(19) United States
(12) Patent Application Publication
(10) Pub. No.: US 2025/0035852 A1
(43) Pub. Date: Jan. 30, 2025

(54) WAVEGUIDE DEVICE AND OPTICAL COUPLING STRUCTURE AND OPTOELECTRONIC SYSTEM USING SAME

(71) Applicant: AIP Inc., New Taipei City (TW)

(72) Inventor: Chia Lee, New Taipei City (TW)

(73) Assignee: AIP Inc., New Taipei City (TW)

(21) Appl. No.: 18/780,660

(22) Filed: Jul. 23, 2024

Related U.S. Application Data
(63) Continuation-in-part of application No. 18/510,668, filed on Nov. 16, 2023.
(60) Provisional application No. 63/649,955, filed on May 21, 2024.
(60) Provisional application No. 63/528,933, filed on Jul. 26, 2023.

(51) Int. Cl. G02B 6/30

(52) U.S. Cl. CPC G02B 6/30

(57) ABSTRACT

An optical coupling structure, adapted for a photonic integrated circuit, includes a waveguide device and an optical fiber assembly. The waveguide device includes a waveguide substrate including a plurality of optical waveguide paths extending between a first guide surface and a second guide surface of the waveguide substrate. The first guide surface defines a first light exit area at which ends of the optical waveguide paths are exposed, the second guide surface defines a second light exit area at which the other ends of the optical waveguide paths are exposed. The second light exit area has an entire length less than at least one-half of an entire length of the first light exit area. The optical fiber assembly is connected to the first guide surface of the waveguide device.

### CROSS REFERENCE TO RELATED APPLICATIONS

This application claims the benefit of U.S. provisional patent application Ser. No. 63/649,955, filed May 21, 2024, the entirety of which is incorporated by reference herein.

This application is a continuation-in-part of U.S. patent application Ser. No. 18/510,668 filed Nov. 16, 2023, which claims the priority of U.S. provisional patent application Ser. No. 63/528,933, filed Jul. 26, 2023, the entireties of which are incorporated by reference herein.

### BACKGROUND OF INVENTION

### 1. Field of Invention

The present invention relates to a technical field of optical coupling, and particularly to a waveguide device, an optical coupling structure for a photonic integrated circuit, and an optoelectronic system.

### 2. Related Art

Light data transmission between optoelectronic integrated circuits (OEICs) and devices connected to the OEICs are through optical components such as optical fibers. Since the amount of data to be transmitted through the optical fibers rapidly grows, OEICs are required to have photonic chips sized for arrangement of an increasing number of optical transmission channels to align with respective fiber cores of the optical fibers. However, multiple optical transmission channels spanning across enlarged sizes of photonic chips bring about a problem of deformation of the photonic chips due to stress of deposition material on the photonic chips. For example, as shown in FIG. 1, opposite side portions 91 of a photonic chip 9 are prone to warp causing misalignment between optical transmission channels 92 and fiber cores 94 of multiple optical fibers 93, which in turn results in ineffective optical signal transmission.

### SUMMARY OF INVENTION

An object of the present application is to provide an optical coupling structure capable of preventing a photonic integrated circuit to which the optical coupling structure is optically coupled from warping.

To achieve the above-mentioned objects, one aspect of the present application is to provide an optical coupling structure, adapted for a photonic integrated circuit. The optical coupling structure includes a waveguide device and an optical fiber assembly. The waveguide device includes a waveguide substrate including a first guide surface and a second guide surface located opposite to the first guide surface, and a plurality of optical waveguide paths arranged on the waveguide substrate and extending between the first guide surface and the second guide surface, wherein the first guide surface defines a first light exit area at which ends of the optical waveguide paths are exposed, the second guide surface defines a second light exit area at which the other ends of the optical waveguide paths are exposed, and the second light exit area has an entire length less than at least one-half of an entire length of the first light exit are. The optical fiber assembly is connected to the first guide surface of the waveguide substrate.

Optionally, the waveguide substrate further includes a first corner portion, a second corner portion, and an intermediate portion located between the first corner portion and the second corner portion and arranged on the second guide surface. The second light exit area is located at the first corner portion, the second corner portion, or the intermediate portion.

Optionally, the waveguide substrate is defined into a first region, a second region, and a third region located between the first region and the second region. The optical waveguide paths in the first region are arranged at a first pitch, and the optical waveguide paths in the second region are arranged at a second pitch less than the first pitch.

Optionally, a pitch between adjacent ones of the optical waveguide paths in the third region is changed from the first pitch to the second pitch such that the optical waveguide paths in the third region are configured in a fan-out and a fan-in arrangement.

Optionally, the optical fiber assembly comprises a plurality of optical fibers, the optical waveguide paths are equal to the optical fibers in number, and the optical waveguide paths arranged in the first region are in alignment with the optical fibers.

Optionally, the waveguide substrate has a length being parallel with the first guide surface and greater than 20 millimeters.

Optionally, a thickness of the waveguide substrate is greater than a thickness of the photonic integrated circuit.

Optionally, the optical waveguide paths are arranged in an array on an upper surface of the waveguide device.

Optionally, the waveguide device is made of a material comprising silica, lithium niobate (LiNbO3), or polymers.

Optionally, the optical waveguide paths are arranged in an array, the entire length of the first light exit area is measured between two outermost optical waveguide paths with respect to the first guide surface, and the entire length of the second light exit area is measured between two outermost optical waveguide paths with respect to the second guide surface.

Another aspect of the present application is to provide a waveguide device, adapted for a photonic integrated circuit. The waveguide device includes a waveguide substrate including a first guide surface and a second guide surface located opposite to the first guide surface; a first corner portion arranged on the second guide surface; a second corner portion arranged on the second guide surface; an intermediate portion located between the first corner portion and the second corner portion and arranged on the second guide surface; and a plurality of optical waveguide paths arranged on the waveguide substrate and extending between the first guide surface and the second guide surface. An end of each of the optical waveguide paths is exposed at the first corner portion, the second corner portion, or the intermediate portion, and another end of each of the optical waveguide paths is exposed at the first guide surface.

Another aspect of the present application is to provide an optoelectronic system including an optoelectronic device including a main board, a load board mounted on the main board, and an electronic integrated circuit mounted on the main board; a photonic integrated circuit disposed on the load board; and a detachable optical coupling structure. The optical coupling structure includes a first connector and a second connector. The first connector is disposed on the load board and includes a base and a waveguide device disposed in the base. The waveguide device includes a waveguide substrate including a first guide surface and a second guide surface located opposite to the first guide surface, and a plurality of optical waveguide paths arranged on the waveguide substrate and extending between the first guide surface and the second guide surface. The first guide surface defines a first light exit area at which ends of the optical waveguide paths are exposed, the second guide surface defines a second light exit area at which the other ends of the optical waveguide paths are exposed, and the second light exit area has an entire length less than at least one-half of an entire length of the first light exit area. The second connector includes an optical fiber assembly and is detachably connected to the first connector.

In the embodiments of the present application, the optical coupling structure includes the waveguide device, which enables an area of the photonic integrated circuit optically coupled with the optical waveguide paths of the waveguide device is significantly reduced and narrowed, thereby preventing misalignment between the optical transmission channels of the photonic integrated circuit and the optical waveguide paths due to warpage at opposite portions of the photonic integrated circuit.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic top plane view showing a conventional optical coupling module.

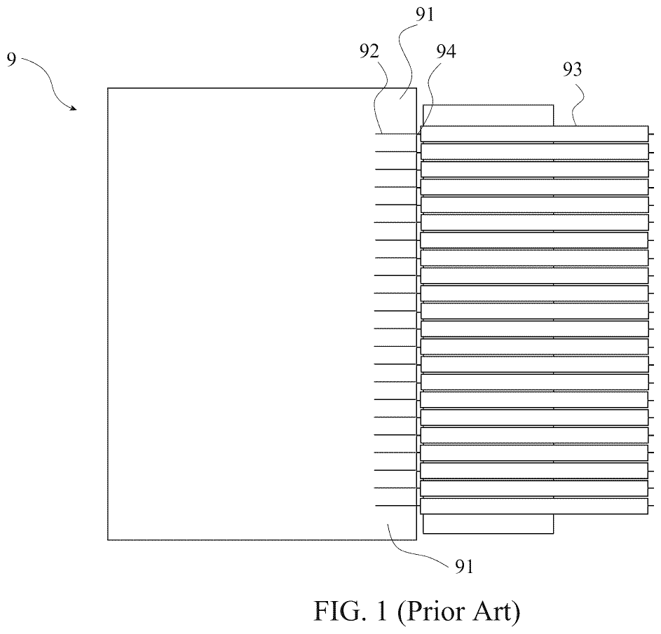

FIG. 2 is a schematic exploded view of an optical coupling structure in accordance with an embodiment of the present application.

FIG. 3A is a schematic structural view of a waveguide device in accordance with an embodiment of the present application.

FIG. 3B is a schematic structural view of a waveguide device in accordance with an embodiment of the present application.

FIG. 4 is a schematic structural view of an optical coupling structure for a photonic integrated circuit in accordance with an embodiment of the present application.

FIG. 5 is a schematic structural view of an optical coupling structure for a photonic integrated circuit in accordance with an embodiment of the present application.

FIG. 6 is a schematic structural view of an optical coupling structure for a photonic integrated circuit in accordance with an embodiment of the present application.

FIG. 7 is a partial enlarged view schematically showing an optical signal transmission device is in alignment with a waveguide device in accordance with an embodiment of the present application.

FIG. 8 is a schematic structural view showing an optoelectronic system in accordance with an embodiment of the present application.

FIG. 9A is a schematic perspective assembly view of a detachable optical coupling structure in accordance with an embodiment of the present application.

FIG. 9B is a schematic view of FIG. 9A with a second connector removed from a first connector.

### DESCRIPTION OF PREFERRED EMBODIMENTS

The following disclosure provides many different embodiments, or examples, for implementing different features of the provided subject matter. Specific examples of components and arrangements are described below to simplify the present application. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present application may repeat reference numerals and/or letters in the various examples. This repetition is for the purpose of simplicity and clarity and does not in itself dictate a relationship between the various embodiments and/or configurations discussed.

The following embodiments are referring to the appendix drawings for exemplifying specific implementable embodiments of the present application. Directional terms described by the present application, such as upper, lower, front, back, left, right, inner, outer, side, etc., are only directions by referring to the drawings, and thus the used directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present application. In addition, the present application may repeat reference numerals and/or letters in the various examples. This repetition is for the purpose of simplicity and clarity and does not in itself dictate a relationship between the various embodiments and/or configurations discussed.

The present application provides an optical coupling structure for a photonic integrated circuit. The photonic integrated circuit may be disposed on an optoelectronic device, which may be a co-packaged optics (CPO) device that integrates at least an electronic integrated circuit (EIC) and at least one photonic integrated circuit (PIC) in a single package for electro-optic conversion or optic-electro conversion.

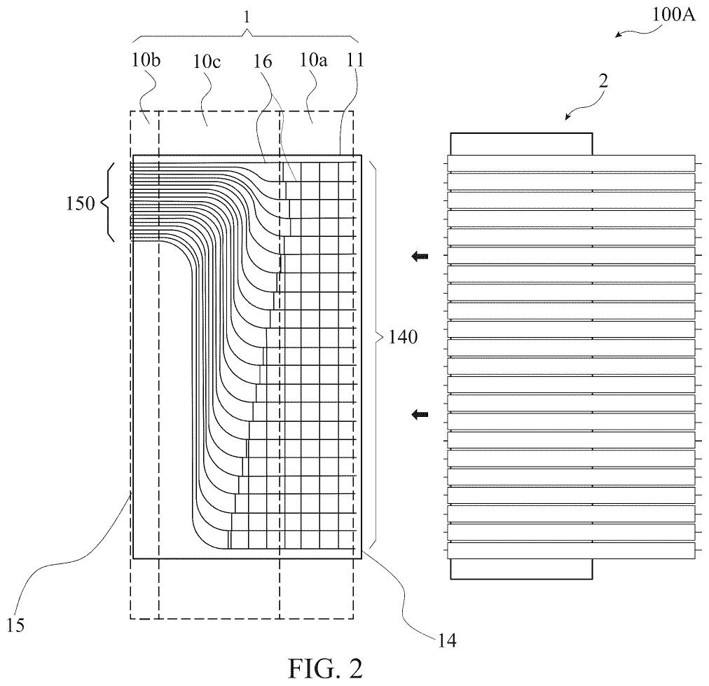

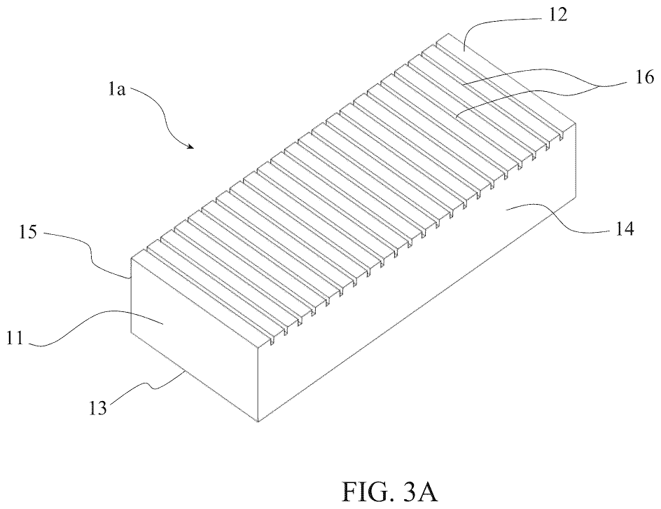

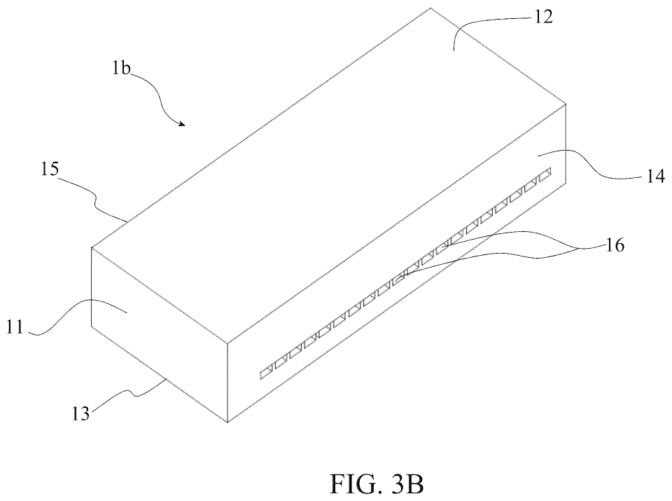

Referring to FIGS. 2 and FIG. 3A, FIG. 2 is a schematic structural view of an optical coupling structure 100A in accordance with an embodiment of the present application, and FIG. 3A is a schematic structural view of a waveguide device in accordance with an embodiment of the present application. As shown in FIG. 2, the optical coupling structure 100A includes a waveguide device 1 and an optical fiber assembly 2. In some embodiments, as shown in FIG. 3A, a basic structure of the waveguide device 1a includes a waveguide substrate 11 which is rectangular in shape and includes an upper surface 12, a lower surface 13 located opposite to the upper surface 12, a first guide surface 14 connected between the upper surface 12 and the lower surface 13, a second guide surface 15 located opposite to the first guide surface 14, and a plurality of optical waveguide paths 16 (shown straight path in FIG. 3A instead of curved path in FIG. 2 for clarity) arranged on the waveguide substrate 11. In some embodiments, the waveguide device 1a is made of a material including, for example, silica. Alternatively, the waveguide device 1a may be made of a material including, lithium niobate (LiNbO3), or polymers, or the waveguide device 1a may have a silicon-on-insulator (SOI) structure.

It is noted that FIG. 3A is mainly intended to illustrate the position of the optical waveguide paths 16 with respect to the waveguide device 1a and therefore does not show the specific and entire layout of the optical waveguide paths 16. In some embodiments, as shown in FIG. 3A, the optical waveguide paths 16 are arranged in an array on the upper surface 12 of the waveguide substrate 11 and configured as an array waveguide grating (AWG) structure. The optical waveguide paths 16 are configured to enable light signal transmission between the photonic integrated circuit and the optical fiber assembly 2. In some embodiments, the waveguide device 1 or 1a is configured for arrangement of at least 32 optical waveguide paths 16, but the number of the optical waveguide paths 16 is not limited thereto and is determined depending on actual requirements. In one embodiment, the waveguide substrate 11 has a length being parallel with the first guide surface 14 and greater than 20 millimeters for covering the arrangement area of 32 optical waveguide paths 16.

Referring to FIG. 3B, a basic structure of the waveguide device 1b shown in FIG. 3B differs from the waveguide device 1a shown in FIG. 3A in the position of the optical waveguide paths 16. As shown in FIG. 3B, the waveguide device 1b includes a plurality of optical waveguide paths 16 arranged in the waveguide device 1b at a position close to the lower surface 13 between first guide surface 14 and the second guide surface 15, so as to work with a tilted micro-reflecting component (not shown for clarity) disposed at the second guide surface 15 in the waveguide device 1b. It should be noted that the arrangement of the optical waveguide paths 16 is not limited to the aforementioned types.

Still referring to FIG. 2, the optical fiber assembly 2 is connected to the first guide surface 14 of the waveguide substrate 11 and includes a plurality of optical fibers 21 arranged in an array. The optical waveguide paths 16 are equal to the optical fibers 21 in number. As shown in FIGS. 2 and 3A, the first guide surface 14 defines a first light exit area 140 at which ends of the optical waveguide paths 16 are exposed, and the second guide surface 15 defines a second light exit area 150 at which the other ends of the optical waveguide paths 16 are exposed. In this embodiment, the second light exit area 150 has an entire length less than at least one-half of an entire length of the first light exit area 140. The optical fibers 21 are in a one-to-one correspondence with the optical waveguide paths 16 with respect to the first light exit area 140. Specifically, the entire length of the first light exit area 140 is measured between two outermost optical waveguide paths 16 with respect to the first guide surface 14, and the entire length of the second light exit area 150 is measured between two outermost optical waveguide paths 16 with respect to the second guide surface 15.

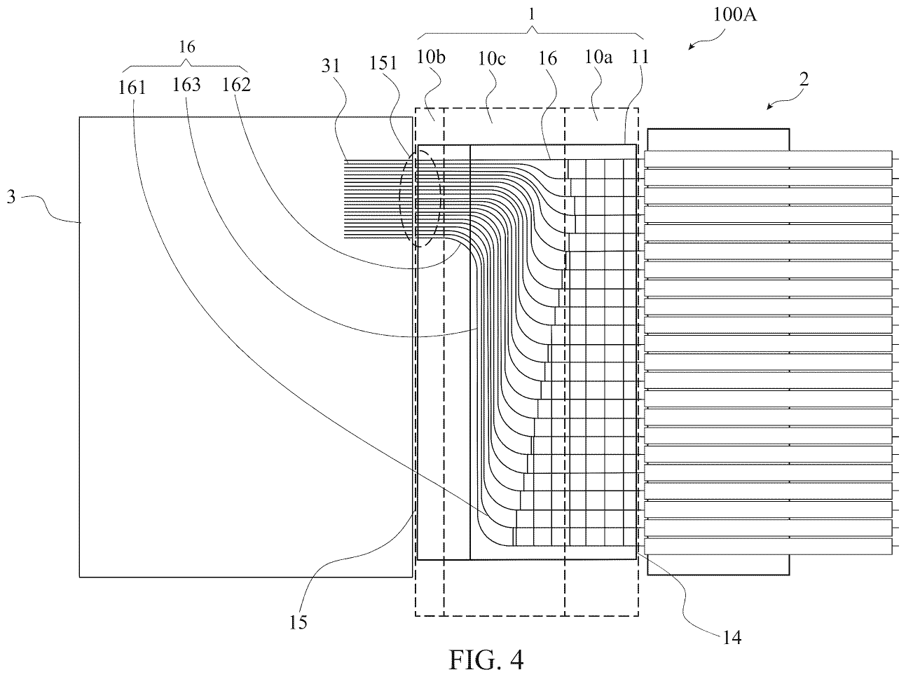

Referring to FIG. 4 and FIG. 2, FIG. 4 is a schematic structural view of the optical coupling structure 100A for a photonic integrated circuit 3 in accordance with an embodiment of the present application. As shown in FIG. 4, the photonic integrated circuit 3 includes a plurality of optical transmission channels 31. One end of the waveguide device 1 is coupled to the photonic integrated circuit 3, the other end is coupled to the optical fiber assembly 2, so that light signal transmission is provided between the photonic integrated circuit 3 and the optical fiber assembly 2 through the waveguide device 1. The waveguide substrate 11 is defined into a first region 10a, a second region 10b, and a third region 10c located between the first region 10a and the second region 10b. As shown in FIG. 4, the waveguide substrate 11 further includes a first corner portion 151 located at an upper left area of the waveguide substrate 11 on the second guide surface 15. Specifically, one end of each of the optical waveguide paths 16 is terminated at the second guide surface 15 in the first corner portion 151 to couple with the plurality of optical transmission channels 31 of the photonic integrated circuit 3. In this embodiment, the second light exit area 150 is located at the first corner portion 151.

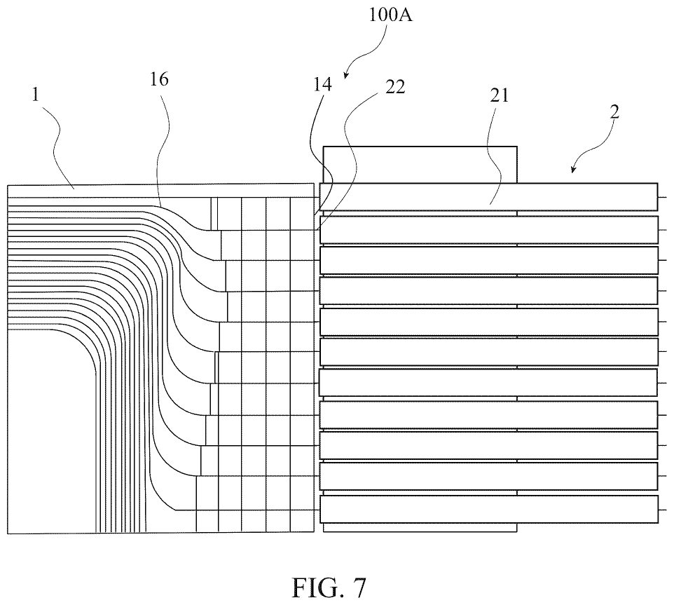

In some embodiments, each of the optical waveguide paths 16 has a width, ranging from 9 microns (μm) to 100 μm, which is determined according to the design of the optical transmission channels 31. As shown in FIG. 4, the optical waveguide paths 16 in the first region 10a are arranged at a first pitch ranging from 100 μm to 300 μm, preferably 125 μm, and are arranged in alignment with the optical fibers 21 (see FIG. 7 described below). The optical waveguide paths 16 in the second region 10b are arranged at a second pitch ranging from 5 μm to 100 μm, preferably 50 μm, and the second pitch is less than the first pitch. In the third region 10c, the optical waveguide paths 16 are arranged at the first pitch at a place close to the first region 10a and arranged at the second pitch at a place close to the second region 10b. In detail, in the third region 10c, the optical waveguide paths 16 bend from the place close to the first region 10a, then extend toward the first corner portion 151, and finally bend again from the place close to the second region 10b.

Still referring to FIG. 4, in some embodiments, each of the optical waveguide paths 16 in the third region 10c includes two symmetrically bent segments 161 and 162 and one straight segment 163. The optical waveguide paths 16 in the third region 10c are parallel with each other in terms of the bent segments 161 and 162 and the straight segments 163, respectively. Specifically, a pitch between adjacent ones of the optical waveguide paths 16 in the third region 10c is changed from the first pitch to the second pitch such that the optical waveguide paths 16 in the third region 10c are configured in a fan-out/fan-in arrangement.

As shown in FIG. 4, with the layout of the optical waveguide paths 16 as described above, the optical waveguide paths 16 span across the entire waveguide device 1 in the first region 10a from the first guide surface 14 to reach the second guide surface 15 in the first corner portion 151, which is narrower than a spacing between the two outermost optical waveguide paths 16 in the first region 10a. Therefore, the second light exit area 150 can be significantly reduced in length while ensuring the light signal transmission from the optical fiber assembly 2 to the photonic integrated circuit 3, and vice versa.

Still referring to FIG. 4, the plurality of optical transmission channels 31 of the photonic integrated circuit 3 occupy only a small area of an edge of the optical transmission channels 31 that a pitch of the plurality of optical transmission channels 31 is less than a pitch of optical fibers 21 (see FIG. 7 described below). By arrangement of the plurality of optical transmission channels 31 according to the embodiment of the disclosure, stress of deposition material on the photonic integrated circuit 3 (i.e., photonic chips) can be reduced that the problem of deformation of the photonic chips can be eased off. In this manner, opposite side portions of a photonic chip will not warp to cause misalignment between the optical transmission channels 31 and fiber cores 22 (see FIG. 7 described below) of the optical fibers 21, which in turn achieves effective optical signal transmission.

In some embodiments, a thickness of the waveguide substrate 11 is greater than a thickness of the photonic integrated circuit 3, such that the thickness of the waveguide substrate 11 is sufficient to prevent the waveguide substrate 11 from warping and to allow the arrangement of a large number of the optical waveguide paths 16, for example, a number of more than 32 waveguide paths.

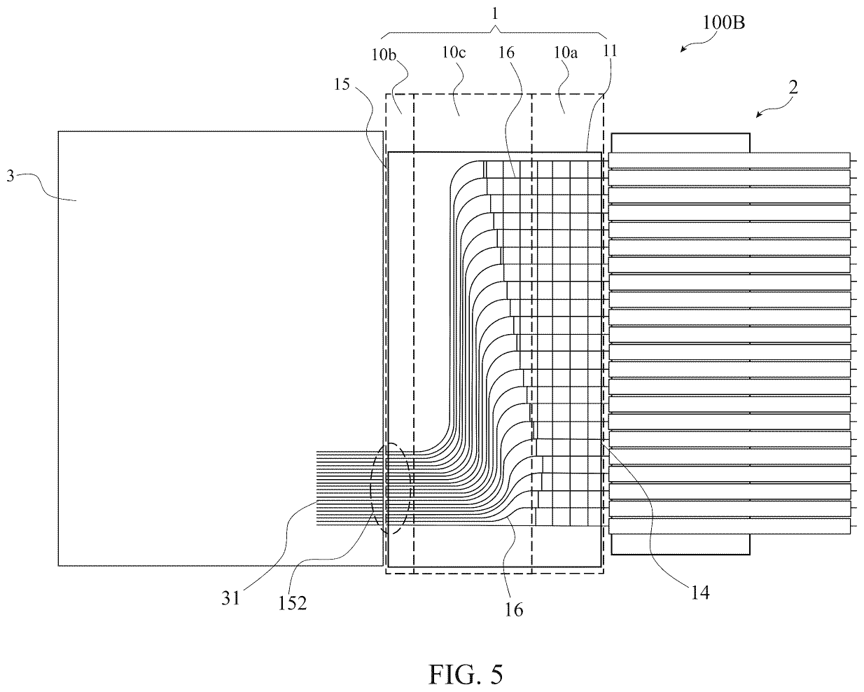

Referring to FIG. 5, FIG. 5 is a schematic structural view of an optical coupling structure 100B for a photonic integrated circuit 3 in accordance with a second embodiment of the present application. The optical coupling structure 100B mainly differs from the optical coupling structure 100A in that the waveguide device 1 includes a second corner portion 152, which is located at a lower left area of the waveguide device 1 and adjoining the second guide surface 15. Similarly, in this embodiment, the optical waveguide paths 16 span across the entire waveguide device 1 in the first region 10a from the first guide surface 14 to reach the second guide surface 15 in the second corner portion 152, which is narrower than a spacing between the two outermost optical waveguide paths 16 in the first region 10a.

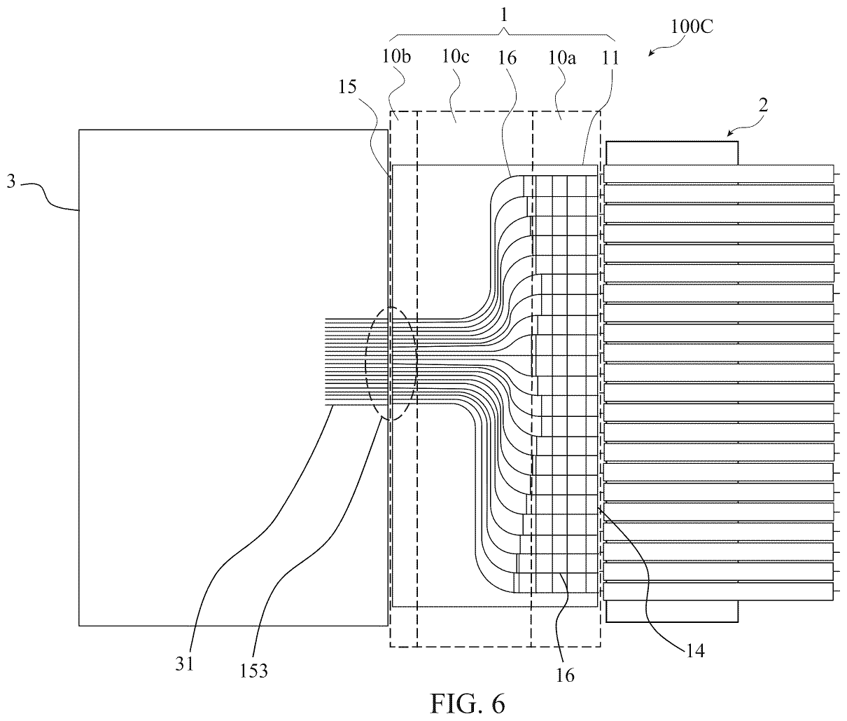

Referring to FIG. 6, FIG. 6 is a schematic structural view of an optical coupling structure 100C for a photonic integrated circuit 3 in accordance with a third embodiment of the present application. The optical coupling structure 100C mainly differs from the optical coupling structures 100A and 100B in that the waveguide device 1 includes an intermediate portion 153, which is located between the lower left area and the upper left area of the waveguide device 1 and adjoining the second guide surface 15. In this embodiment, the optical waveguide paths 16 in the third region 10c are symmetrically arranged such that the layout of the optical waveguide paths 16 are divided half-and-half. The optical waveguide paths 16 span across the entire waveguide device 1 in the first region 10a from the first guide surface 14 to reach the second guide surface 15 in the intermediate portion 153, which is narrower than a spacing between the two outermost optical waveguide paths 16 in the first region 10a.

Referring to FIG. 7 in combination with FIG. 4, FIG. 7 is a partial enlarged view schematically showing an optical fiber assembly is in alignment with a waveguide device. In some embodiments, the optical fiber assembly 2 includes a plurality of optical fibers 21 arranged in parallel with each other in a single row or multiple rows and extending to and exposed at the first guide surface 14. In some embodiments, the optical fibers 21 may be, for example, single-mode fibers, multi-mode fibers, or polarization-maintaining fibers. Each of the optical fibers 21 has a fiber core 22, which is in optical alignment with respective one of the optical waveguide paths 16 so that light beams can be propagated to the waveguide device 1. Diameters of the fiber core 22 ranges from 8.3 μm to 62.5 μm. In some embodiments,, a diameter of a cladding layer of the optical fiber 21 is 125 μm, and a diameter of the optical fibers 21 (including coating layer) is 250 μm.

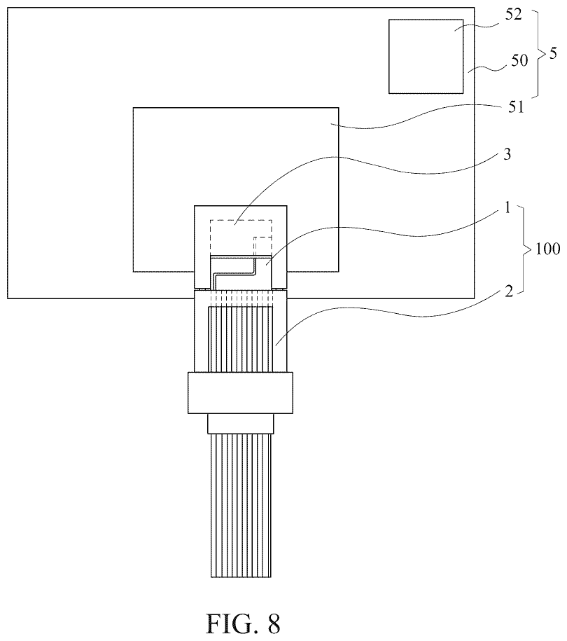

Referring to FIG. 8, FIG. 8 is a schematic structural view showing an optoelectronic system 6. The optoelectronic system 6 includes an optical coupling structure 100, the photonic integrated circuit 3, and a co-packaged optoelectronic device 5. In detail, the optical coupling structure 100 includes the waveguide device 1 and the optical fiber assembly 2 as described in the above embodiments. The optoelectronic device 5 includes a main board 50, and a load board 51 and an electronic integrated circuit 52 mounted on the main board 50. The photonic integrated circuit 3 is disposed on the load board 51 to be co-packaged within the co-packaged optoelectronic device 5. In some embodiments, the co-packaged optoelectronic device 5 is applicable to switches.

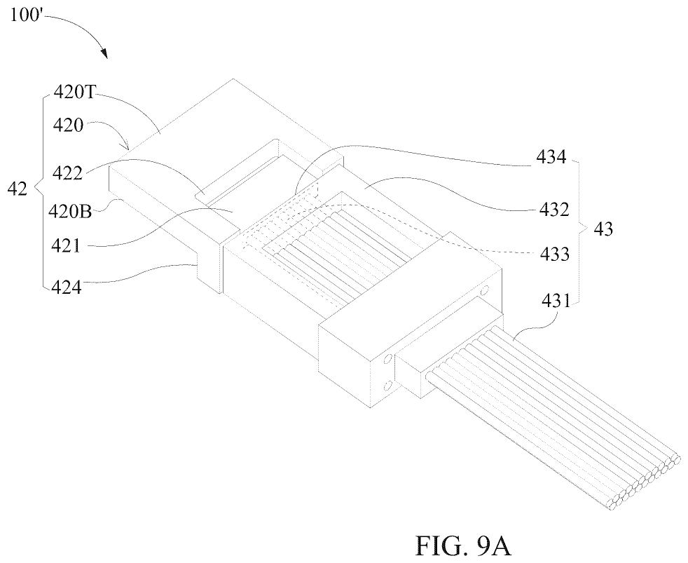

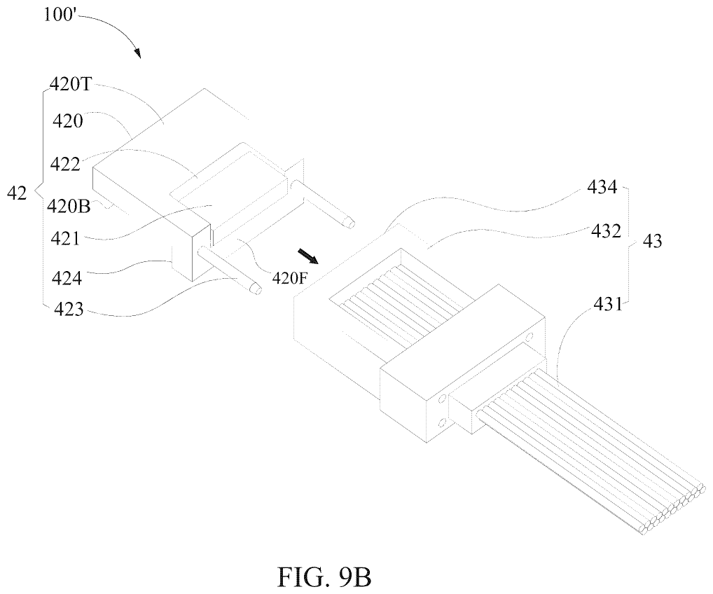

Referring to FIGS. 9A and 9B, FIG. 9A is a schematic perspective assembly view of a detachable optical coupling structure in accordance with an embodiment of the present application, and FIG. 9B is a schematic exploded view of FIG. 9A with a second connector removed from a first connector. In some embodiments, the optoelectronic system 6 further includes a detachable optical coupling structure 100′. The optical coupling structure 100′ includes a first connector 42 and a second connector 43 detachably connected to the first connector 42 that can achieve the effect of easy replacement of the second connector 43. As shown in FIGS. 9A and 9B, the first connector 42 includes a base 420 and a waveguide device 421 as described in the above embodiments. The base 420 includes a lower surface 420B, an upper surface 420T, and a front end 420F connected between the lower surface 420B and the upper surface 420T. In some embodiments, a cutout portion 422 is formed in the base 420 and is recessed from the front end 420F, and the waveguide device 421 is disposed in the cutout portion 422. In detail, the cutout portion 422 is configured to pass through parts of the lower surface 420B, the upper surface 420T, and the front end 420F of the base 420. It is noted that the waveguide device 421 may be the waveguide device 1 in any one of the aforementioned embodiments as shown in FIGS. 2 to 7.

In some embodiments, as shown in FIG. 9B, a plurality of positioning elements 423 are symmetrically arranged on the front end 420F of the base 420 with respect to a middle of the base 420, and are spaced apart from each other on opposite sides of the cutout portion 422 and the waveguide device 421. A retaining wall 424 is formed on the base 420 and bends and extends downward from the lower surface 420B such that the base 420 has an inverted L-shaped cross-sectional profile. In this embodiment, there are two positioning elements 423, which are pin-like in shape and extend in an outward direction from the front end 420F on the retaining wall 424, respectively. In some embodiments, the base 420 is made of material having the characteristic of high temperature resistance, such as ceramic or metal, which is, for example, zirconium dioxide (ZrO2). Alternatively, the base 420 may be made of non-metal material, such as organic binders (e.g., resin), polymer, or plastic.

In some embodiments, the waveguide device 421 may be formed using a material of such as fused silica, quartz, glass, borosilicate glass, etc. It should be noted that the waveguide device 421 includes a planar lightwave circuit (PLC). In some embodiments, the planar lightwave circuit may be configured in various ways configured in a fan-out/fan-in arrangement. Various types of waveguide circuits or devices can be utilized for the planar lightwave circuit in the embodiments of the present application.

Still referring to FIGS. 9A and 9B, in some embodiments, the second connector 43 includes the optical fibers 431 and a mating component 432 structured to be detachably connected to the first connector 42. It is noted that the optical fibers 431 may be the optical fibers 21 in any one of the aforementioned embodiments as shown in FIGS. 2 to 7. The optical fibers 431 have a plurality of fiber ends 433 terminated at the mating component 432 (as shown in FIG. 9A). In this embodiment, the mating component 432 functions as an optical multi-channel connector and includes a connecting surface 434 arranged facing the front end 420F of the base 420, and a plurality of recesses (not show) of the mating component 432 arranged to correspond to the pin-like positioning elements 423. As shown in FIG. 9A, the second connector 43 is plugged into the first connector 42. As shown in FIG. 9B, the second connector 43 can be removed from the base 420 of the first connector 42.

In this arrangement, as shown in FIG. 9A, the fiber ends 433 of the optical fibers 431 are positioned to directly face the cutout portion 422 at the front end 420F of the base 420 to enable signal transmission between the optical fibers 431 and the waveguide device 421 in a way of surface coupling. It should be noted that the signal transmission between the optical fibers 431 and the waveguide device 421 is not limited to the surface coupling type as described above, and may be various in forms of optical coupling.

Accordingly, the present application provides the optical coupling structure including the waveguide device, which enables an area of the photonic integrated circuit optically coupled with the optical waveguide paths of the waveguide device is significantly reduced and narrowed, thereby preventing misalignment between the optical transmission channels of the photonic integrated circuit and the optical waveguide paths due to warpage at opposite portions of the photonic integrated circuit.

One aspect of the present application provides an optical coupling structure 100, which is adapted for a photonic integrated circuit 3. The optical coupling structure 100 includes a waveguide device 1 comprising a waveguide substrate 11 comprising a first guide surface 14 and a second guide surface 15 located opposite to the first guide surface 14, and a plurality of optical waveguide paths 16 arranged on the waveguide substrate 11 and extending between the first guide surface 14 and the second guide surface 15. The first guide surface 14 defines a first light exit area 140 at which ends of the optical waveguide paths 16 are exposed, the second guide surface 15 defines a second light exit area 150 at which the other ends of the optical waveguide paths 16 are exposed, and the second light exit area 150 has an entire length less than at least one-half of an entire length of the first light exit area 140; and an optical fiber assembly 2 connected to the first guide surface 14 of the waveguide device 1.

Another aspect of the present application provides a waveguide device 1, which is adapted for a photonic integrated circuit 3. The waveguide device 1 includes a waveguide substrate 11 including a first guide surface 14 and a second guide surface 15 located opposite to the first guide surface 14; a first corner portion 151 arranged on the second guide surface 15; a second corner portion 152 arranged on the second guide surface 15; an intermediate portion 153 located between the first corner portion 151 and the second corner portion 152 and arranged on the second guide surface 15; and a plurality of optical waveguide paths 16 arranged on the waveguide substrate 11 and extending between the first guide surface 14 and the second guide surface 15. An end of each of the optical waveguide paths 16 is exposed at the first corner portion 151, the second corner portion 152, or the intermediate portion 153, and another end of each of the optical waveguide paths 16 is exposed at the first guide surface 14.

Another aspect of the present application provides an optoelectronic system 6 including an optoelectronic device 5 including a main board 50, a load board 51 mounted on the main board 50, and an electronic integrated circuit 52 mounted on the main board 50; a photonic integrated circuit 3 disposed on the load board 51; and a detachable optical coupling structure 100. The optical coupling structure 100 includes a first connector 42 and a second connector 43. The first connector 42 is disposed on the load board 51 and includes a base 420 and a waveguide device 421(1) disposed in the base 420. The waveguide device 1 includes a waveguide substrate 11 including a first guide surface 14 and a second guide surface 15 located opposite to the first guide surface 14, and a plurality of optical waveguide paths 16 arranged on the waveguide substrate 11 and extending between the first guide surface 14 and the second guide surface 15. The first guide surface 14 defines a first light exit area 140 at which ends of the optical waveguide paths 16 are exposed, the second guide surface 15 defines a second light exit area 150 at which the other ends of the optical waveguide paths 16 are exposed, and the second light exit area 150 has an entire length less than at least one-half of an entire length of the first light exit area 140. The second connector 43 includes an optical fiber assembly 2 (including optical fibers 21/431) and is detachably connected to the first connector 42.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. An optical coupling structure, adapted for a photonic integrated circuit, the optical coupling structure comprising:
a waveguide device comprising a waveguide substrate comprising a first guide surface and a second guide surface located opposite to the first guide surface, and a plurality of optical waveguide paths arranged on the waveguide substrate and extending between the first guide surface and the second guide surface, wherein the first guide surface defines a first light exit area at which ends of the optical waveguide paths are exposed, the second guide surface defines a second light exit area at which the other ends of the optical waveguide paths are exposed, and the second light exit area has an entire length less than at least one-half of an entire length of the first light exit area; and
an optical fiber assembly connected to the first guide surface of the waveguide substrate.

2. The optical coupling structure of claim 1, wherein the waveguide substrate further comprises a first corner portion, a second corner portion, and an intermediate portion located between the first corner portion and the second corner portion and arranged on the second guide surface, wherein the second light exit area is located at the first corner portion, the second corner portion, or the intermediate portion.

3. The optical coupling structure of claim 1, wherein the waveguide substrate is defined into a first region, a second region, and a third region located between the first region and the second region, wherein the optical waveguide paths in the first region are arranged at a first pitch, and the optical waveguide paths in the second region are arranged at a second pitch less than the first pitch.

4. The optical coupling structure of claim 3, wherein a pitch between adjacent ones of the optical waveguide paths in the third region is changed from the first pitch to the second pitch such that the optical waveguide paths in the third region are configured in a fan-out and a fan-in arrangement.

5. The optical coupling structure of claim 3, wherein the optical fiber assembly comprises a plurality of optical fibers, the optical waveguide paths are equal to the optical fibers in number, and the optical waveguide paths arranged in the first region are in alignment with the optical fibers.

6. The optical coupling structure of claim 1, wherein the waveguide substrate has a length being parallel with the first guide surface and greater than 20 millimeters.

7. The optical coupling structure of claim 1, wherein a thickness of the waveguide substrate is greater than a thickness of the photonic integrated circuit.

8. The optical coupling structure of claim 1, wherein the optical waveguide paths are arranged in an array on an upper surface of the waveguide device.

9. The optical coupling structure of claim 1, wherein the waveguide device is made of a material comprising silica, lithium niobate (LiNbO3), or polymers.

10. The optical coupling structure of claim 1, wherein the optical waveguide paths are arranged in an array, the entire length of the first light exit area is measured between two outermost optical waveguide paths with respect to the first guide surface, and the entire length of the second light exit area is measured between two outermost optical waveguide paths with respect to the second guide surface.

11. A waveguide device, adapted for a photonic integrated circuit, the waveguide device comprising:
a waveguide substrate comprising a first guide surface and a second guide surface located opposite to the first guide surface;
a first corner portion arranged on the second guide surface;
a second corner portion arranged on the second guide surface;
an intermediate portion located between the first corner portion and the second corner portion and arranged on the second guide surface; and
a plurality of optical waveguide paths arranged on the waveguide substrate and extending between the first guide surface and the second guide surface;
wherein an end of each of the optical waveguide paths is exposed at the first corner portion, the second corner portion, or the intermediate portion, and another end of each of the optical waveguide paths is exposed at the first guide surface.

12. The waveguide device of claim 11, wherein the waveguide substrate is defined into a first region, a second region, and a third region located between the first region and the second region, wherein the optical waveguide paths in the first region are arranged at a first pitch, the optical waveguide paths in the second region are arranged at a second pitch less than the first pitch.

13. The waveguide device of claim 12, wherein a pitch between adjacent ones of the optical waveguide paths in the third region is changed from the first pitch to the second pitch such that the optical waveguide paths in the third region are configured in a fan-out and a fan-in arrangement.

14. The waveguide device of claim 11, wherein an optical fiber assembly is connected to the first guide surface of the waveguide substrate, and the optical fiber assembly comprises a plurality of optical fibers equal to the optical waveguide paths in number.

15. The waveguide device of claim 11, wherein the waveguide device is made of a material comprising silica, lithium niobate (LiNbO3), or polymers.

16. The waveguide device of claim 11, wherein a thickness of the waveguide substrate is greater than a thickness of the photonic integrated circuit.

17. An optoelectronic system, comprising:
an optoelectronic device comprising a main board, a load board mounted on the main board, and an electronic integrated circuit mounted on the main board;
a photonic integrated circuit disposed on the load board; and
a detachable optical coupling structure;
wherein the optical coupling structure comprises:
a first connector disposed on the load board and comprising:
a base; and
a waveguide device disposed in the base and comprising a waveguide substrate comprising a first guide surface and a second guide surface located opposite to the first guide surface, and a plurality of optical waveguide paths arranged on the waveguide substrate and extending between the first guide surface and the second guide surface, wherein the first guide surface defines a first light exit area at which ends of the optical waveguide paths are exposed, the second guide surface defines a second light exit area at which the other ends of the optical waveguide paths are exposed, and the second light exit area has an entire length less than at least one-half of an entire length of the first light exit area; and
a second connector comprising an optical fiber assembly, wherein the second connector is detachably connected to the first connector.

18. The optoelectronic system of claim 17, wherein the waveguide substrate further comprises a first corner portion, a second corner portion, and an intermediate portion located between the first corner portion and the second corner portion and arranged on the second guide surface, wherein the second light exit area is located at the first corner portion, the second corner portion, or the intermediate portion.

19. The optoelectronic system of claim 17, wherein the optical fiber assembly comprises a mating component, and part of the optical fibers is terminated at an edge of the mating component close to the waveguide device.
